(19) United States
(12) Patent Application Publication
(10) Pub. No.: US 2025/0378381 A1
(43) Pub. Date: Dec. 11, 2025

(54) TASK-SPECIFIC MODIFICATION OF PRE-TRAINED LANGUAGE MODELS

(71) Applicant: Georgia Tech Research Corporation, Atlanta, GA (US)

(72) Inventors: Tyler Christopher Lizzo, Norcross, GA (US); Larry Paul Heck, Atlanta, GA (US)

(21) Appl. No.: 19/229,601

(22) Filed: Jun. 5, 2025

Related U.S. Application Data
(60) Provisional application No. 63/656,660, filed on Jun. 6, 2024.

(51) Int. Cl. G06N 20/00

(52) U.S. Cl. CPC G06N 20/00

(57) ABSTRACT

Methods and systems are disclosed for selectively modifying the behavior of a pre-trained language model with respect to a designated task. A task-specific subspace is identified by training low-rank matrices for selected layers of the trained machine learning model, while freezing other parameters. The identified subspace is used to either attenuate or enhance task contributions by adjusting one or more model weight matrices. In some embodiments, overlapping subspaces are discriminated to preserve related task performance. These operations can be performed without access to original training data or full retraining. Some aspects of the disclosed techniques can allow efficient knowledge removal or addition in language models while minimizing adverse effects on unrelated tasks.

### RELATED APPLICATIONS

The present application claims priority benefit to U.S. Provisional App. No. 63/656,660, entitled “EFFICIENT KNOWLEDGE MANAGEMENT SYSTEM FOR LARGE LANGUAGE MODELS,” filed Jun. 6, 2024, which is hereby incorporated herein by reference in its entirety.

### GOVERNMENT SUPPORT

This invention was made with government support under Grant No. HR0011-23-3-0002 awarded by the Department of Defense/Defense Advanced Research Projects Agency (DARPA). The government has certain rights in the invention.

### FIELD

The present disclosure generally relates to machine learning systems and, more particularly, to techniques for modifying the behavior of large language models by selectively adjusting task-specific knowledge without performing full retraining.

### BACKGROUND

Large language models (LLMs) are increasingly used in a variety of practical applications involving natural language processing. While such models can be effective across a wide range of language-related tasks, they may encounter limitations when performing certain operations, such as arithmetic computation or causal reasoning. For these specific types of tasks, smaller or more specialized systems can often provide higher efficiency or accuracy. In some system architectures, task-specific functionality may be handled by external tools, allowing the LLM to delegate certain operations outside the trained machine learning model. In such cases, the internal parameters of the trained machine learning model that contribute to those externally delegated tasks may become unnecessary. Reducing or eliminating these parameters can potentially improve resource utilization and reduce computational cost.

Conventional approaches to modifying model behavior typically involve retraining the trained machine learning model using data associated with a desired change. For example, to remove the trained machine learning model's capability for a given task, training data corresponding to that task can be excluded and the trained machine learning model retrained. However, retraining a large model from scratch can be computationally expensive and time-consuming, particularly as model scale increases. As a result, such approaches may not be practical for many real-world systems.

A range of approaches have been developed to modify trained models with reduced computational burden, including methods that adapt only a subset of model parameters or selectively adjust specific behaviors. These techniques may be applied to improve model performance on new tasks, or to reduce reliance on certain types of training data. While such strategies can be effective in some settings, their applicability to large-scale models may be constrained by implementation complexity or performance tradeoffs.

### SUMMARY

Some aspects of the present disclosure relate to system and methods for efficiently modifying large language models (LLMs) by adding or removing task or domain-specific knowledge while preserving performance on non-targeted or overlapping tasks. This is accomplished through techniques that identify and manipulate task-specific weight matrices within the trained machine learning model to facilitate rapid adaptation. The approach can employ a modified low-rank adaptation (LoRA) training process, where the attention weights of a pre-trained model are sequentially frozen and then trained using task-specific data. This generates a unique set of attention weights representing the target task, allowing precise knowledge management within the trained machine learning model.

Some aspects of the present disclosure relate to system that implements advanced separation techniques to distinguish and isolate weight matrices across various tasks or domains. An enhanced method similar to the Gram-Schmidt process can be used to project and subtract overlapping task domains, ensuring that modifications to one task do not negatively impact adjacent tasks. This inventive concept facilitates targeted addition and removal of knowledge to and from LLMs, making them adaptable for different applications while maintaining overall efficiency. The disclosed inventive concepts can be particularly beneficial for applications requiring frequent updates, strict data privacy compliance, and/or resource optimization, offering a significant improvement over existing machine-learning techniques.

Certain illustrative examples are described in the following numbered clauses:

Clause 1. A method for selectively modifying a trained machine learning model with respect to a designated task, the method including:
obtaining a trained machine learning model including a plurality of layers, each layer defined by a respective weight matrix;
identifying a designated task, the designated task corresponding to a functionality associated with the trained machine learning model;
for each layer in the plurality of layers:
maintaining weight matrices of all other layers of the plurality of layers of the trained machine learning model in an unmodified state, and
generating a task subspace matrix corresponding to the designated task by determining a rank-constrained transformation associated with the respective layer, wherein the transformation is computed using data representative of the designated task and applied solely one or more weights of the respective layer;
forming a composite task subspace by aggregating the task subspace matrices generated across the plurality of layers, the composite task subspace representing parameter contributions in the trained machine learning model specific to the designated task; and
modifying at least one weight matrix of the trained machine learning model in accordance with the composite task subspace, thereby adjusting a contribution of the designated task to an output of the trained machine learning mode.

Clause 2. The method of Clause 1, further including:
identifying one or more reference subspaces, each reference subspace corresponding to a task distinct from the designated task, and each reference subspace being derived by computing a rank-constrained transformation based on data representative of the respective distinct task, wherein, for each computation, all other weight matrices of the trained machine learning model are maintained in an unmodified state;
generating a modified subspace representation by discriminating the composite task subspace from the one or more reference subspaces, the modified subspace representation retaining components unique to the designated task and excluding components shared with the reference subspaces,
wherein modifying includes modifying the at least one weight matrix of the trained machine learning model in accordance with the modified subspace representation.

Clause 3. The method of clause 2, wherein discriminating the composite task subspace from the one or more reference subspaces includes orthogonalizing vector components of the composite task subspace with respect to the reference subspaces, such that only components not shared with the reference subspaces are retained in a modified subspace representation.

Clause 4. The method of clause 2, wherein modifying at least one weight matrix includes performing a subtraction of the modified subspace representation from a corresponding one of the at least one weight matrix, to attenuate functionality associated with the designated task, thereby reducing a contribution of the designated task to an output of the trained machine learning model.

Clause 5. The method of clause 2, wherein the modified subspace representation is generated as a linear interpolation between the task subspace matrix and a corresponding discriminated task subspace matrix, the interpolation governed by a smoothing factor configured to balance an extent of task attenuation and preservation of performance on similar tasks.

Clause 6. The method of any of the preceding clauses, wherein identifying the designated task includes selecting the designated task for attenuation based on a determination that the functionality associated with the designated task is redundant with respect to an external system, such that the modification of the trained machine learning model reduces parameter usage attributable to the designated task while preserving performance on unrelated tasks.

Clause 7. The method of any of the preceding clauses, wherein modifying at least one weight matrix includes performing an addition of the composite task subspace to the at least one weight matrix, thereby increasing a contribution of the designated task to the output of the trained machine learning model.

Clause 8. The method of clause 7, wherein the addition of the composite task subspace to the at least one weight matrix is performed in a manner that maintains approximate orthogonality with preexisting task subspaces, thereby enhancing performance on the designated task without adversely affecting performance on semantically similar tasks.

Clause 9. The method of any of the preceding clauses, wherein generating the task subspace matrix for each respective layer includes determining a low-rank transformation matrix by factorizing the transformation as a product of a first matrix and a second matrix, each having a dimensionality lower than that of the corresponding weight matrix, the factorization implementing a bottleneck architecture configured to reduce parameter dimensionality.

Clause 10. The method of any of the preceding clauses, wherein generating the task subspace matrices includes sequentially training across the plurality of layers of layers by, for each layer in the plurality of layers, computing the task subspace matrix while maintaining all other weight matrices in the plurality of layers in an unmodified state, thereby isolating training to the respective layer.

Clause 11. The method of any of the preceding clauses, wherein the at least one weight matrix includes one or more attention-related weight matrices of the trained machine learning model.

Clause 12. The method of any of the preceding clauses, wherein generating the task subspace matrix for each respective layer includes computing a low-rank transformation defined by a product of a first matrix and a second matrix, the product being constrained such that each matrix has fewer parameters than the corresponding weight matrix, the computation implementing a bottleneck structure to reduce parameter dimensionality while preserving task-specific expressiveness.

Clause 13. The method of any of the preceding clauses, wherein the at least one weight matrix includes one or more weight matrices within attention layers of the trained machine learning model, and wherein modifying the at least one weight matrix is confined to the attention-related weight matrices, thereby limiting an effect of the modification to mechanisms governing token-to-token interactions within the trained machine learning model.

Clause 14. The method of any of the preceding clauses, wherein the modifying of the at least one weight matrix is performed without retraining all of the plurality of layers of the trained machine learning model and without requiring access to any original training data used to produce the trained machine learning model.

Clause 15. A non-transitory computer-readable medium storing instructions that, when executed by one or more processors, cause a computing system to perform a method comprising:
obtaining a trained machine learning model including a plurality of layers, each layer defined by a respective weight matrix;
identifying a designated task, the designated task corresponding to a functionality associated with the trained machine learning model;
for each layer in the plurality of layers:
maintaining weight matrices of all other layers of the plurality of layers of the trained machine learning model in an unmodified state, and
generating a task subspace matrix corresponding to the designated task by determining a rank-constrained transformation associated with the respective layer, wherein the transformation is computed using data representative of the designated task and applied solely one or more weights of the respective layer;
forming a composite task subspace by aggregating the task subspace matrices generated across the plurality of layers, the composite task subspace representing parameter contributions in the trained machine learning model specific to the designated task; and
modifying at least one weight matrix of the trained machine learning model in accordance with the composite task subspace, thereby adjusting a contribution of the designated task to an output of the trained machine learning mode.

Clause 16. The non-transitory computer-readable medium of Clause 15, further including:
identifying one or more reference subspaces, each reference subspace corresponding to a task distinct from the designated task, and each reference subspace being derived by computing a rank-constrained transformation based on data representative of the respective distinct task, wherein, for each computation, all other weight matrices of the trained machine learning model are maintained in an unmodified state;
generating a modified subspace representation by discriminating the composite task subspace from the one or more reference subspaces, the modified subspace representation retaining components unique to the designated task and excluding components shared with the reference subspaces,
wherein modifying includes modifying the at least one weight matrix of the trained machine learning model in accordance with the modified subspace representation.

Clause 17. The non-transitory computer-readable medium of Clause 15, wherein discriminating the composite task subspace from the one or more reference subspaces includes orthogonalizing vector components of the composite task subspace with respect to the reference subspaces, such that only components not shared with the reference subspaces are retained in a modified subspace representation.

Clause 18. A system for selectively modifying a trained machine learning model with respect to a designated task, the system comprising:
one or more processors; and
memory storing instructions that, when executed by the one or more processors, cause the system to:
obtain a trained machine learning model including a plurality of layers, each layer defined by a respective weight matrix;
identify a designated task, the designated task corresponding to a functionality associated with the trained machine learning model;
for each layer in the plurality of layers:
maintain weight matrices of all other layers of the plurality of layers of the trained machine learning model in an unmodified state, and
generate a task subspace matrix corresponding to the designated task by determining a rank-constrained transformation associated with the respective layer, wherein the transformation is computed using data representative of the designated task and applied solely one or more weights of the respective layer;
form a composite task subspace by aggregating the task subspace matrices generated across the plurality of layers, the composite task subspace representing parameter contributions in the trained machine learning model specific to the designated task; and
modify at least one weight matrix of the trained machine learning model in accordance with the composite task subspace, thereby adjusting a contribution of the designated task to an output of the trained machine learning mode.

Clause 19. The system of Clause 18, wherein the instructions further cause the system to:
identify one or more reference subspaces, each reference subspace corresponding to a task distinct from the designated task, and each reference subspace being derived by computing a rank-constrained transformation based on data representative of the respective distinct task, wherein, for each computation, all other weight matrices of the trained machine learning model are maintained in an unmodified state; and
generate a modified subspace representation by discriminating the composite task subspace from the one or more reference subspaces, the modified subspace representation retaining components unique to the designated task and excluding components shared with the reference subspaces,
wherein modifying includes modifying the at least one weight matrix of the trained machine learning model in accordance with the modified subspace representation.

Clause 20. The system of Clause 18, wherein discriminating the composite task subspace from the one or more reference subspaces includes orthogonalizing vector components of the composite task subspace with respect to the reference subspaces, such that only components not shared with the reference subspaces are retained in a modified subspace representation.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1 illustrates a block diagram of an example system for selectively modifying a trained machine learning model with respect to a designated task.

FIG. 2 illustrates an example architecture and processing sequence for generating a task-specific subspace from a trained machine learning model using rank-constrained transformation matrices associated with individual layers.

FIG. 3 illustrates an example bottleneck architecture that can be used to implement a rank-constrained transformation associated with a layer of a trained machine learning model.

FIG. 4 illustrates an example of comparative task performance degradation when GSM8K is designated as the target task for removal

### DETAILED DESCRIPTION

### Introduction

Various machine learning applications involve selectively modifying the behavior of large language models (LLMs) in response to evolving functional, operational, or contextual requirements. In certain situations, it may be beneficial to attenuate model capabilities associated with specific tasks—such as those that are redundant, outdated, or sensitive—or to enhance performance on tasks introduced after initial training. In some cases, such modifications may be preferred without accessing the original training data or performing a full retraining of the trained machine learning model. Conventional approaches to task-specific modification often rely on fine-tuning or data-dependent editing techniques, which may introduce inefficiencies or interfere with performance on related tasks.

Some inventive concepts described herein relate to systems, methods, and computer-readable media that can support the selective modification of a trained machine learning model's behavior in a targeted and efficient manner. These concepts may enable the adjustment of model functionality with respect to particular tasks, such as reducing or enhancing certain capabilities, while maintaining performance on unrelated tasks to a desired extent. In some implementations, such modifications can be performed without requiring full retraining of the trained machine learning model, without access to the original training data, and/or without materially impacting knowledge associated with other tasks. This functionality may be useful in scenarios involving domain-specific adaptation, policy compliance, knowledge removal, or integration of new capabilities.

Some inventive concepts described herein relate to systems, methods, and computer-readable media that can suppress or attenuate task-specific behavior within a trained machine learning model. In some embodiments, the system may operate in an UNLEARN mode, where selected capabilities, such as responding to particular question types or performing specific functions, are reduced or removed. This suppression may be desirable in scenarios involving, for example, sensitive, redundant, or outdated content. The system may apply targeted edits based on structured representations of task-specific knowledge, allowing the modification to be isolated and efficient, and, in some cases, without degrading the trained machine learning model's general utility or requiring full retraining.

Some inventive concepts described herein relate to systems, methods, and computer-readable media that can strengthen or augment a model's performance on a designated task. In some embodiments, the system may operate in a LEARN mode to improve functional accuracy or alignment with a target behavior. For example, the system can enhance performance on specific benchmarks, expand coverage of domain-specific tasks, or refine output consistency in line with user requirements. These adjustments may be performed using structured representations of task-specific knowledge, which can be integrated into the trained machine learning model in a manner that preserves its broader capabilities. In some embodiments, this functionality enables targeted, reversible modifications that do not require access to the original training data or full retraining of the trained machine learning model. Such enhancements can support practical applications including enterprise-level customization, task-specific fine-tuning in constrained environments, or rapid deployment of new features aligned with evolving operational needs.

Some inventive concepts described herein relate to techniques for adjusting task-specific functionality within a trained machine learning model by leveraging representations which may be referred to as task subspaces. A task subspace can reflect the portion of a model's parameter space that contributes to a particular capability, behavior, or output pattern. In some embodiments, subspaces associated with a designated task may be isolated and either added to or subtracted from the trained machine learning model to respectively amplify or suppress the task's influence. These modifications can, in some cases, be performed without accessing the original training dataset and without retraining all model layers, providing a streamlined and data-efficient approach to model editing.

In some embodiments, at least some of the functionality described herein includes subspace discrimination, in which a designated task's subspace is differentiated from reference subspaces associated with other tasks. This can allow the system to refine task-specific representations by isolating components that are more distinctive to the designated task and/or removing components that are likely shared with others. As a result, in some cases, the system can support selective unlearning of specific task behaviors without broadly degrading related functionality or generalization.

Some embodiments described herein may leverage a unified representation framework in which a given task subspace can be applied in multiple directions. For instance, the same subspace may be used in a subtractive manner to suppress the task or in an additive manner to enhance it (LEARN), depending on the objective. This dual-mode capability may simplify integration and facilitate consistent treatment of task representations across workflows involving knowledge removal, editing, or augmentation.

In some embodiments, the inventive concepts described herein can support structured, reversible adjustment of task-specific capabilities within a trained machine learning model using shared subspace representations. A unified task matrix representation may be reused across both suppression and enhancement modes, enabling streamlined and consistent modification workflows. In some embodiments, the disclosed approaches can achieve substantial suppression of task behavior (e.g., approximately 96% attenuation on the target task) while maintaining performance on unrelated tasks within 2.5% of the original baseline. Even when the target task shares semantic similarity with others, the system can, in some instances, achieve approximately 91% forgetting while maintaining accuracy on similar tasks within 1.1%. These performance characteristics may exceed those of conventional techniques, which in some cases demonstrate comparable forgetting at the cost of broader task degradation. In some cases, enhancement functionality (e.g., LEARN mode) may support performance improvements comparable to parameter-efficient fine-tuning methods, such as LoRA, while avoiding degradation of adjacent capabilities. Accordingly, the system can facilitate targeted knowledge editing through a subspace-based representation framework that supports dual-mode operations while maintaining generalization and preserving model integrity.

In some embodiments, the system may include components configured to define, isolate, transform, and/or apply task-specific subspaces. For example, a task specification unit may determine which capability to target, while a layer selection controller may identify layers to be modified. A subspace generator may compute low-rank transformations that reflect task-related behavior, and a reference subspace generator may construct comparative embeddings for adjacent tasks. In some embodiments, a subspace discriminator may refine the task subspace to avoid unintended overlap, and a parameter adjustment unit may apply modifications to relevant model weights. In some cases, the same task-specific subspace matrix may be reused across suppression and enhancement operations, enabling the system to apply the matrix subtractively in UNLEARN mode or additively in LEARN mode. This shared structure simplifies implementation while supporting consistent, reversible updates across workflows involving capability removal or targeted augmentation.

In light of the description provided herein, it will be understood that the inventive concepts disclosed can represent a substantial improvement in the field of model adaptation or machine learning system flexibility. Specifically, the systems or methods described herein can enable selective adjustment of task-specific behavior in a trained machine learning model, potentially without requiring access to the original training data, without full retraining, or without substantially degrading performance on unrelated or semantically similar tasks. The disclosed functionality can allow a system to identify or isolate parameter subspaces associated with designated tasks, compute modifications in a constrained or layer-targeted manner, or apply those transformations additively or subtractively to influence model output. In some cases, the ability to generate or manipulate structured subspace representations can facilitate efficient fine-tuning, suppression, or enhancement of task-specific behavior with minimal computational overhead. These capabilities can support diverse deployment requirements, such as post-deployment model customization, domain-specific regulatory compliance, iterative knowledge updates, or the controlled removal of outdated or sensitive information. By offering precise, reversible, or low-overhead modification mechanisms, the inventive concepts described herein can improve the operational scalability, adaptability, or lifecycle management of large-scale machine learning systems.

Accordingly, the presently disclosed embodiments can improve the functionality of machine learning model infrastructure by supporting efficient, selective, or reversible updates to task-specific capabilities. These improvements can address technical challenges commonly associated with traditional fine-tuning or unlearning workflows, such as resource-intensive retraining, unintended knowledge loss, or difficulty preserving generalization across tasks. The disclosed systems can offer technical solutions to these challenges by incorporating subspace-based task modeling, layer-targeted transformation, or composite subspace discrimination techniques that may be applied without altering the core model architecture. As a result, the systems or methods described herein can represent a notable advancement over conventional approaches to model editing, continual learning, or knowledge management in machine learning environments.

### System Overview

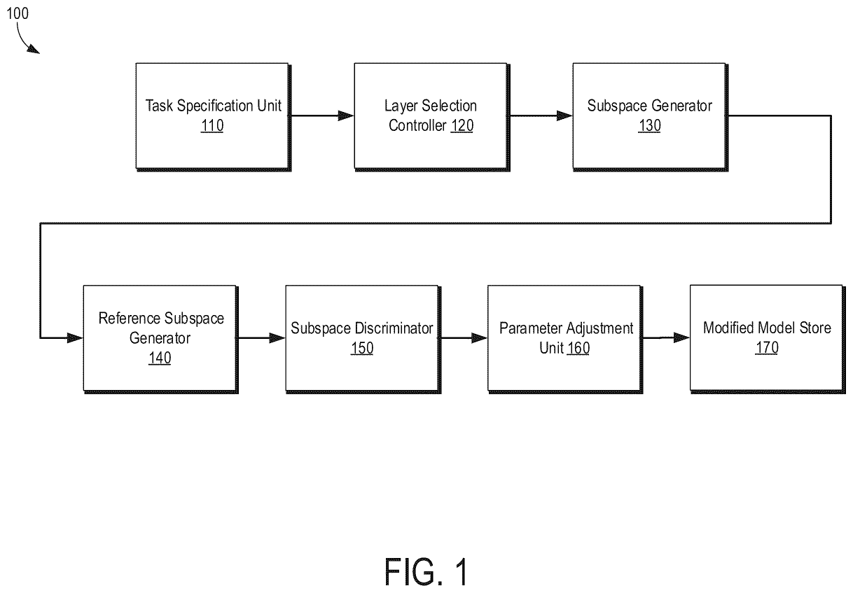

FIG. 1 illustrates a block diagram of an example system 100 for selectively modifying a trained machine learning model with respect to a designated task. The system 100 includes a task specification unit 110, a layer selection controller 120, a subspace generator 130, a reference subspace generator 140, a subspace discriminator 150, a parameter adjustment unit 160, and a modified model store 170. To simplify discussion and not to limit the present disclosure, FIG. 1 illustrates a single instance of each component. In some embodiments, fewer, additional, or different components may be used. The illustrated flow path represents one example of data and control flow; other communication sequences, parallelization strategies, or interaction models may be employed.

Any of the foregoing components or subsystems of the system 100 may communicate via one or more networks. Although not explicitly shown, such networks may include local or distributed computing environments. The network(s) can include any suitable communication infrastructure, including local area networks (LANs), wide area networks (WANs), peer-to-peer systems, cloud computing platforms, or wireless networks. Communication may occur via wired or wireless connections, or through any appropriate data transmission mechanisms.

Each of the components or subsystems of the system 100, including but not limited to the task specification unit 110, the layer selection controller 120, the subspace generator 130, the reference subspace generator 140, the subspace discriminator 150, the parameter adjustment unit 160, and the modified model store 170, may be implemented using one or more computing devices. In some embodiments, these components may be realized as software executed on one or more processors, as firmware or hardware, or as any combination thereof. Two or more functions may be performed by a single component, and/or any single function may be distributed across multiple components.

The system 100 may be deployed on standalone servers, distributed platforms, containerized environments, or edge/cloud-based infrastructure. In some embodiments, one or more of the components may be instantiated as microservices, background processes, execution pipelines, or virtualized instances operating within an orchestration framework.

The arrangement shown in FIG. 1 is illustrative only. Fewer, additional, or alternative components may be used. In some embodiments. Logical data flows between components may reflect various modes of interaction, such as shared memory, inter-process communication, distributed queues, or API-based integration. The system is not limited to any specific data transport, format, or messaging protocol.

In some embodiments, the system 100 is configured to identify, isolate, modify, or suppress subspaces of learned representations corresponding to designated tasks within a machine learning model. The functionality may include low-rank transformation, task-specific subspace construction, subspace discrimination relative to reference tasks, or selective adjustment of model parameters to enhance or diminish task-related functionality.

The task specification unit 110 is configured to identify, define, or receive a representation of a designated task associated with a trained machine learning model. A “designated task” (sometimes referred to as “task”) may refer broadly to any capability, behavior, or model output that reflects a particular learned functionality. Examples of designated tasks include, but are not limited to, answering domain-specific questions such as those in medical, legal, or financial contexts; solving arithmetic or mathematical problems; generating or completing source code; classifying sentiment or emotion in written text; translating between natural languages; or responding to prompts according to specific formatting, tone, or instruction-following patterns. The task specification unit 110 can enable the system 100 to isolate and modify such task-specific behaviors within the trained machine learning model.

The task specification unit 110 is configured to accept task inputs through a variety of mechanisms. In some embodiments, the designated task may be specified explicitly through a user interface, a configuration file, a system management dashboard, or a control API. For example, a developer may provide a benchmark name such as GSM8K, BIG-Bench, or LegalBench, or select a task category from a curated catalog. In some embodiments, the task specification unit 110 may operate on a prompt example or a small set of labeled input-output instances. For instance, the system 100 may receive a few-shot prompt demonstrating legal reasoning, arithmetic calculation, or factual recall, and the task specification unit 110 may use those examples to characterize the scope and structure of the designated task.

The task specification unit 110 may be configured to derive or infer tasks based on signals such as dataset structure, metadata fields, token-level patterns, or prompt content. In some embodiments, the task specification unit 110 may classify tasks using example prompts, label types, or feature distributions. For example, a dataset may contain pairs of user questions and legal citations, enabling the task specification unit 110 to categorize the task as legal question-answering. A corpus of short reviews and corresponding sentiment scores may be used to specify a sentiment classification task. The task specification unit 110 may support template-based task recognition, statistical matching, or model-driven classification.

The task specification unit 110 is configured to generate a structured representation of the designated task that can allow coordinated operation across components of system 100. This representation may include symbolic identifiers, task embeddings computed from training samples, benchmark tags, descriptive metadata, or structured templates describing input-output schema. The task specification unit 110 may perform preparation steps such as sequence formatting, class balancing, token mapping, and schema validation to ensure task compatibility with downstream subspace modification processes. This representation can be passed to components responsible for isolating and transforming parameters associated with the task.

The task specification unit 110 may be implemented in software, firmware, hardware, or any suitable combination. The task specification unit 110 may operate as a discrete service, a callable function, or an integrated module within an orchestration pipeline. The task specification unit 110 may be used in connection with LEARN operations that increase task-specific behavior or UNLEARN operations that attenuate or suppress it. Through this functionality, the task specification unit 110 can enable system 100 to dynamically manage the knowledge encoded within a trained machine learning model, for example either to enhance performance on desired tasks or to remove or neutralize specific capabilities.

The layer selection controller 120 is configured to determine which subset of model layers within a trained machine learning model is to be modified in connection with a designated task. In general, a trained machine learning model may include of a plurality of layers, each defined by a corresponding weight matrix that contributes to the trained machine learning model's output. The layer selection controller 120 can allow selective targeting of one or more of these layers to localize the impact of task-specific modifications. This focused approach supports efficient training, avoids unnecessary alteration of unrelated model behavior, and allows fine-grained control over how and where the trained machine learning model is adapted.

In some embodiments, the layer selection controller 120 operates according to predefined rules or heuristics based on the architecture of the underlying model. For example, in transformer-based architectures such as Llama-2, certain layers are known to encode higher-level semantics (e.g., early layers) or more task-specific patterns (e.g., later layers). The layer selection controller 120 may be configured to select only the later layers for modification when enhancing or removing a task that depends on detailed factual or linguistic behavior. In some settings, the layer selection controller 120 may include logic for selecting alternating layers, attention-related layers, or bottleneck modules based on efficiency or model capacity considerations.

The layer selection controller 120 can support dynamic or adaptive selection strategies. In some embodiments, the layer selection controller 120 may analyze a task specification or dataset characteristics to identify which layers are most relevant to the designated task. For example, tasks involving arithmetic, legal reasoning, or summarization may activate different portions of the trained machine learning model. The layer selection controller 120 may employ techniques such as gradient analysis, attention profiling, or relevance attribution to select a minimal yet effective set of layers. In some embodiments, historical performance metrics or learned policies may be used to guide future layer selection decisions.

The layer selection controller 120 is configured to provide the selected subset of layers to other system components, including those responsible for generating task-specific transformations. For each selected layer, a corresponding task subspace matrix may be generated while the remaining layers are held fixed. This layer-isolated training can allow the system 100 to determine how the designated task is encoded in the trained machine learning model and facilitates downstream operations such as subspace discrimination or model adjustment.

The layer selection controller 120 may be implemented in software, firmware, or hardware, and may be embodied as a service module, orchestration rule, training script, or interface element. In some embodiments, the layer selection controller 120 operates in coordination with the task specification unit 110, such that the nature of the task can influence which layers are selected. The layer selection controller 120 may allow for manual override or configuration via user input, particularly when domain experts or model developers wish to impose custom constraints on model adaptation.

The layer selection controller 120 supports a range of model modification workflows by identifying layers associated with a designated task. These workflows may include adjustments that increase or decrease the trained machine learning model's responsiveness to specific tasks, depending on the desired outcome. For example, in some enhancement scenarios (sometimes referred to as LEARN-mode operations) such as boosting performance on domain-specific benchmarks (e.g., LegalBench or GSM8K), the layer selection controller 120 may select layers that are most influential in expressing the targeted task. In some suppression scenarios (sometimes referred to as UNLEARN-mode operations), such as removing functionality related to privacy-sensitive or redundant knowledge, the layer selection controller 120 may identify layers where the task is predominantly encoded for selective attenuation. The layer selection controller 120 can constrain modifications to targeted regions of the trained machine learning model, helping preserve unrelated capabilities and avoiding the need for full retraining.

The subspace generator 130 is configured to compute a task-specific transformation for one or more selected layers of a trained machine learning model, thereby identifying the subspace of model parameters that is attributable to a designated task. In this context, a “subspace” may refer to a lower-dimensional representation embedded within the weight space of the trained machine learning model that encapsulates how the trained machine learning model performs a given task. By isolating these task-related components, the subspace generator 130 can allow downstream processes to selectively modify model behavior without requiring access to the original training data or retraining the entire model.

The subspace generator 130 operates over a trained model including a plurality of layers, each defined by a corresponding weight matrix. For a selected layer, the subspace generator 130 produces a transformation matrix that captures the contribution of the designated task to that layer's behavior. This transformation is computed using a dataset, prompt sequence, or task representation obtained from the task specification unit 110. The transformation may be constrained to a low-rank form to reduce parameter dimensionality while preserving task-relevant information. In some embodiments, the transformation is factorized into a pair of lower-dimensional matrices, such as F and G, that define a bottleneck architecture consistent with efficient fine-tuning methods like LoRA.

The subspace generator 130 may apply a sequential training strategy across layers to isolate the effect of the designated task. During this process, in some cases, the subspace generator 130 freezes all other layers in the trained machine learning model and allows only the selected layer to be updated while optimizing a loss function tied to the designated task. This may involve maximizing the conditional likelihood of task outputs given inputs, minimizing a classification loss over labeled data, or aligning predicted completions with task-specific expectations. For example, when the task is solving math word problems (e.g., GSM8K) or performing legal reasoning (e.g., LegalBench), the subspace generator 130 updates the selected layer's transformation matrix until performance plateaus on a validation set, then freezes the layer and moves to the next.

The output of the subspace generator 130 includes one or more task subspace matrices, each corresponding to a specific layer. These matrices may be stored temporarily or persistently and used to form a composite task subspace that spans all selected layers. The composite subspace can be interpreted as a latent encoding of how the trained machine learning model accomplishes the designated task across multiple layers. In some embodiments, these subspace matrices are passed directly to a subspace discriminator 150 or to a parameter adjustment unit 160 for further modification or integration into the trained machine learning model.

In some embodiments, the subspace generator 130 may be configured to operate in either a LEARN mode or an UNLEARN mode. In LEARN mode, the generated task subspace is used to augment the trained model, increasing its performance on the designated task. In UNLEARN mode, the same subspace may be used to attenuate or remove the trained machine learning model's performance on that task. Because the subspace generator 130 produces consistent, aligned representations, these subspaces may be added or subtracted from the trained machine learning model weights depending on the desired direction of modification. This dual-purpose design can allow unified training workflows and reduces system complexity.

The subspace generator 130 may be implemented using neural network training code, scripted pipelines, modular service endpoints, or containerized components integrated within a model management system. In some embodiments, the subspace generator 130 includes controls for rank selection, early stopping, batch size, or optimizer parameters to balance training fidelity and computational cost. The subspace generator 130 may support integration with libraries such as LORALIB or Hugging Face Transformers, enabling reuse of existing infrastructure to generate targeted subspaces for a broad range of language tasks.

The reference subspace generator 140 is configured to construct one or more subspace representations corresponding to tasks distinct from a designated task. Each such representation, which may be referred to as a reference subspace, is used to characterize knowledge that is not intended to be altered within the machine learning model. By generating these reference subspaces, the reference subspace generator 140 provides a comparative basis for identifying which portions of the trained machine learning model's behavior or learned parameters are unique to the designated task versus shared with other tasks. This capability can be importatnt in scenarios where selective unlearning must preserve adjacent task performance, or where targeted knowledge enhancement must avoid redundant additions.

In operation, the reference subspace generator 140 may receive task definitions, metadata, or training data associated with one or more known auxiliary tasks. These tasks may span a wide variety of domains, such as question answering, natural language inference, summarization, code generation, or entity classification. In a representative example, the designated task may involve legal reasoning (e.g., as defined by LegalBench), while the reference subspace generator 140 may be configured to generate subspaces for other tasks such as general trivia (e.g., BIG-Bench), math problem solving (e.g., GSM8K), or biomedical question answering. The reference subspace generator 140 processes these secondary tasks using a methodology consistent with the subspace generator 130, such as layer-specific training with frozen context layers and bottleneck matrix factorization.

The reference subspace generator 140 may construct each subspace matrix by training on a single layer of the trained machine learning model at a time while freezing all others, thereby isolating the layer-specific contribution of the task to the trained machine learning model's internal representation. In this way, each reference subspace matrix captures a rank-constrained transformation specific to a distinct task and aligned to the architecture of the trained model. In some embodiments, the reference subspace generator 140 may process a curated collection of benchmark tasks in parallel to reduce latency, or may sequentially construct task subspaces in environments with limited resources. The reference subspace generator 140 may combine both parallel and sequential processing strategies across different layers or tasks, depending on available system resources and performance requirements.

The reference subspace generator 140 is configured to combine individual reference subspaces into a composite subspace for use in subspace discrimination. The composite may take the form of, including but not limited to, a concatenated matrix, an averaged basis representation, or another aggregated structure that captures overlapping dimensions across tasks. This aggregation provides a basis for distinguishing shared knowledge components from task-specific features during the discrimination and modification processes.

The reference subspace generator 140 may be implemented using modular software, distributed services, or embedded routines within a larger machine learning pipeline. The reference subspace generator 140 may include logic to select reference tasks based on relevance to the designated task, coverage of a specific domain, user-defined policies, or system usage logs. For instance, the system 100 may automatically prioritize reference subspace generation for high-usage benchmarks, tasks marked as sensitive, or those historically prone to interference during unlearning. The generated reference subspaces can be passed to the subspace discriminator 150 for further analysis and transformation, supporting selective and controlled adjustment of model behavior.

The subspace discriminator 150 is configured to transform a task-specific subspace representation by separating the components that are task-specific or unique to a designated task from those that are shared with one or more reference tasks. This functionality supports selective modification of the trained machine learning model by distinguishing between task-related and shared components. The subspace discriminator 150 performs subspace-level discrimination between the designated task and reference subspaces to modify functionality associated with the designated task while limiting changes to unrelated behavior. In some embodiments, the resulting subspace may retain residual components that are also relevant to other tasks. For example, this may be the case when tasks exhibit semantic or functional similarity, such as legal reasoning and general reading comprehension. The discrimination process can maximize separation based on representational differences, subject to the expressiveness and granularity of the underlying model architecture.

In some embodiments, the subspace discriminator 150 receives as input a composite task subspace generated by the subspace generator 130 and one or more reference subspaces produced by the reference subspace generator 140. The composite task subspace can represent a low-rank embedding of parameter contributions associated with the designated task, and the reference subspaces can represent learned components for other tasks. Using these inputs, the subspace discriminator 150 identifies and isolates those components of the designated task subspace that are not represented in the reference subspaces.

The subspace discriminator 150 may implement a variety of discrimination techniques, such as orthogonalization, projection, or decomposition methods. In some examples, the subspace discriminator 150 employs a modified Gram-Schmidt process or singular value decomposition (SVD) to identify a basis for the designated task subspace that is linearly independent from the basis of the reference subspaces. This process may be applied individually per model layer, allowing shared features at each level of abstraction, such as lexical semantics in early layers or reasoning patterns in later layers, to be selectively excluded from a final subspace representation. The result can be a modified subspace representation that retains the unique influence of the designated task while excluding information likely to affect other tasks.

The subspace discriminator 150 may implement smoothing strategies in which the output subspace is generated as a linear combination of the original task subspace and the discriminated subspace. This approach allows the system to adjust the degree of task isolation and provides a mechanism for balancing task removal or enhancement with the preservation of generalization. A smoothing factor or interpolation parameter may be defined based on user preferences, automated validation loss metrics, or performance thresholds on related benchmarks.

The subspace discriminator 150 may be deployed as a software module, a containerized function, or a component of a model modification service. The subspace discriminator 150 can operate independently or as part of an integrated training and editing pipeline. In some examples, the subspace discriminator 150 supports batch processing across multiple tasks and layers, enabling scalable operations for systems that manage large numbers of tasks or models. The output of the subspace discriminator 150 can be passed to the parameter adjustment unit 160, which can use the discriminated subspace to perform targeted model modification while reducing the likelihood of unintended degradation to other capabilities.

The parameter adjustment unit 160 is configured to modify one or more weight matrices of a trained machine learning model in accordance with a task-specific subspace representation. In some cases, a goal of the parameter adjustment unit 160 is to attenuate or enhance the trained machine learning model's functional response to a designated task, based on the selective inclusion or removal of components derived from that task's subspace. This process allows for the controlled alteration of the trained machine learning model's behavior without requiring full retraining or access to the original training dataset.

In some embodiments, the parameter adjustment unit 160 receives as input a subspace representation generated by the subspace generator 130 or, where applicable, a modified subspace representation produced by the subspace discriminator 150. This input defines a low-rank transformation associated with the designated task and may reflect components that are primarily attributable to that task, particularly when adjusted through comparison with reference tasks. The parameter adjustment unit 160 uses this subspace representation to update the trained model's internal parameters in a layer-specific manner.

The parameter adjustment unit 160 may apply one or more operations to perform the modification, depending on the selected mode of use and the characteristics of the subspace representation. For example, in a task attenuation or UNLEARN mode, the parameter adjustment unit 160 may subtract the task subspace representation from one or more weight matrices of the trained machine learning model to reduce the trained machine learning model's responsiveness to the designated task. In a task enhancement or LEARN mode, the parameter adjustment unit 160 may add the subspace representation to increase the trained machine learning model's effectiveness on the task. In some embodiments, the parameter adjustment unit 160 may apply alternative or supplementary operations, including but not limited to: scaling the subspace representation to control its relative influence; interpolating between the original and modified weights using a smoothing factor; projecting model weights orthogonally away from the task subspace to reduce task alignment; or selectively replacing specific matrix components based on thresholds or relevance scores. These adjustments may be applied on a per-layer basis, such as modifying attention-related weights within specific Transformer blocks, or across a defined subset of layers selected by the layer selection controller 120. The parameter adjustment unit 160 may implement these operations using matrix arithmetic or other transformation techniques that preserve compatibility with the architecture and internal consistency of the trained machine learning model.

In some embodiments, the parameter adjustment unit 160 is configured to perform a smoothing operation. For example, the parameter adjustment unit 160 may compute a linear interpolation between the original task subspace and a modified task subspace, where the interpolation is governed by a smoothing factor. The smoothing factor defines the relative weighting of the original and discriminated components within the resulting subspace representation. This operation may be used to modulate the extent of task-specific modification, supporting a balance between complete removal and partial suppression of task-related behavior. In some embodiments, the smoothing operation may assist in reducing unintended impact on tasks with overlapping or semantically related features.

The parameter adjustment unit 160 may be implemented using model editing APIs, weight injection routines, or in-memory tensor modification techniques. In distributed settings, the parameter adjustment unit 160 may coordinate updates across parallel devices or containerized model replicas. The parameter adjustment unit 160 can be integrated into model training pipelines, deployment workflows, or task-specific evaluation systems. Once the weight matrix modifications are complete, the adjusted model may be stored, deployed, or further evaluated, with the results logged or routed to the modified model store 170.

The parameter adjustment unit 160 is configured to support targeted and data-efficient transformation of a trained machine learning model, including subtraction-based forgetting and/or addition-based adaptation. This operational flexibility facilitates application across a range of scenarios, such as, but not limited to, removing knowledge associated with sensitive or privacy-regulated content, fine-tuning a deployed model on newly introduced tasks without full retraining, performing incremental updates in continual learning settings, or adjusting task-specific behavior to comply with domain-specific regulatory or policy requirements. Examples include suppressing model outputs related to medical diagnoses in restricted jurisdictions, augmenting performance on legal reasoning tasks post-deployment, or removing redundant capabilities in systems operating alongside external knowledge engines.

The modified model store 170 is configured to store, manage, or provide access to one or more instances of a trained machine learning model that have been selectively modified with respect to a designated task. These modified instances may reflect either the attenuation or enhancement of task-specific capabilities, depending on whether the system has performed a forgetting or learning operation. In some embodiments, the modified model store 170 may store a baseline version of the original, unmodified trained model for purposes such as comparison, rollback, audit, or reinitialization. The modified model store 170 functions as a persistent repository and distribution layer for retaining and deploying both adjusted and baseline model instances.

The modified model store 170 may be used in a variety of deployment scenarios. For example, after the parameter adjustment unit 160 has altered the trained machine learning model weights in accordance with a designated task's subspace, the resulting model instance may be committed to the modified model store 170 for later inference, benchmarking, safety validation, or user feedback. This can allow downstream systems to make use of models with targeted behaviors, such as a version of the trained machine learning model that no longer answers questions about sensitive medical data or one that has improved capabilities in legal document summarization.

The modified model store 170 may be implemented using file systems, object storage platforms, container registries, or model versioning services. The modified model store 170 may support a variety of model formats, including serialized checkpoints, framework-native bundles (e.g., PyTorch or TensorFlow), or optimized inference-ready artifacts. In some embodiments, the modified model store 170 may be integrated into a model hub or model lifecycle management platform, supporting metadata tagging, version history, rollback functionality, and access control.

Each stored model instance in the modified model store 170 may be associated with a structured record describing the task transformation that has occurred. Such records may include identifiers for the designated task, the nature of the transformation (e.g., subtraction-based forgetting or addition-based enhancement), the layers modified, and the source of the task data or subspace representation. This metadata can allow traceability and reproducibility across multiple training or editing cycles.

The modified model store 170 may interface with orchestration systems to support automated deployment into production or staging environments. For example, the modified model store 170 may expose an API or message queue through which downstream components can request a specific version of the trained machine learning model with defined task capabilities. In some embodiments, the modified model store 170 may track usage statistics, performance metrics, or validation outcomes for each modified model to inform future model editing decisions.

The modified model store 170 supports applications in privacy compliance, domain adaptation, continuous learning, or enterprise AI governance. By providing a structured mechanism for storing selectively altered model instances, the modified model store 170 facilitates responsible deployment and efficient reuse of large language models tailored to specific functional or ethical constraints.

### Example UNLEARN Method

Various approaches in the field of machine learning relate to modifying or adapting pre-trained models in a computationally efficient manner. For example, some techniques allow for adjustment of model behavior with reduced training overhead, such as updating a subset of model parameters or applying structured transformations to portions of the trained machine learning model. These approaches can reduce memory usage or training time while supporting improved performance on designated tasks.

Some efforts have been made to develop systems that can remove or suppress specific learned information from machine learning models. This area, sometimes referred to as unlearning, may be motivated by factors such as data privacy, regulatory compliance, or the desire to remove outdated or redundant capabilities. In some cases, methods have been proposed to isolate knowledge associated with specific inputs or tasks and reduce its influence without broadly degrading overall model performance. However, these approaches can face limitations in scalability, reversibility, or precision.

In some embodiments, some techniques described herein involve one or several operations, including, but not limited to, subspace identification, subspace discrimination, or subspace removal. A task-specific subspace may be identified by generating a knowledge (task)-dependent matrix for each designated layer of a trained machine learning model, with all other layers maintained in an unmodified state (e.g., freezing all other layers). This process can be performed in a sequential, layer-by-layer manner across the trained machine learning model to produce a set of matrices representing the task-dependent subspace. A subspace discrimination operation may be used to isolate components of this task subspace that are distinctive to the designated task while preserving information shared with other tasks. This may be achieved, in some cases, by applying an orthogonalization procedure, such as a variation of the Gram-Schmidt process, to reduce interference between overlapping subspaces, allowing mutual information to be preserved. The resulting representation may be referred to as a modified task matrix, T′ᵢ. A subspace removal operation may then be applied, wherein the modified task matrix, T′ᵢ, is subtracted from one or more model parameters to reduce the trained machine learning model's alignment with the designated task while maintaining performance on unrelated or semantically similar tasks.

### Subspace Identification

Subspace identification can refer to the process of determining a representation of task-specific behavior within the weight space of a large language model (LLM). The method may utilize a general training procedure that is implemented layer-by-layer, starting with the first layer ( [symbol] =1). All training may be performed with a train/validation/test split of 0.60/0.20/0.20: The train set may be used for training the network, the validation set may determine when to stop training for a specific layer to prevent overfitting, and all evaluations may be performed on the final test set.

Model Initialization: The original pre-trained weights of the LLM may be disregarded or replaced, and the weights for all layers may be randomly initialized.

Layer Freezing: Except for the weights at layer [symbol] , all other weights for the subsequent layers of an LLM may remain fixed to isolate the training to one layer at a time.

Training Procedure: With the [symbol] -th layer unfrozen and the remaining layers frozen, the system may perform training using a dataset representative of the designated task. In some embodiments, the training objective includes maximizing a conditional language modeling likelihood, such as the expression shown in Equation (1). This objective may guide updates to the weights at the E-th layer in order to model the conditional distribution of output tokens given prior context and input. Equation (1) is shown below:

$${max}_{{T}_{i}^{l}} {\sum }_{( x , y ) ∈ ℨ} {{\sum }_{t = 1}}^{\vert y \vert} log ( {P}_{{T}_{i}^{l}} ( {y}_{t} \vert x , y < t ) ) \qquad ( 1 )$$

where xᵢ and yᵢ are sequences of tokens and

$${T}_{i}^{l} ∈ {n \times n}^{}$$

is the matrix for task i at the [symbol] -th layer and n×n the dimensions of the original pre-trained weight matrix.

Given that the matrix

$${T}_{i}^{l}$$

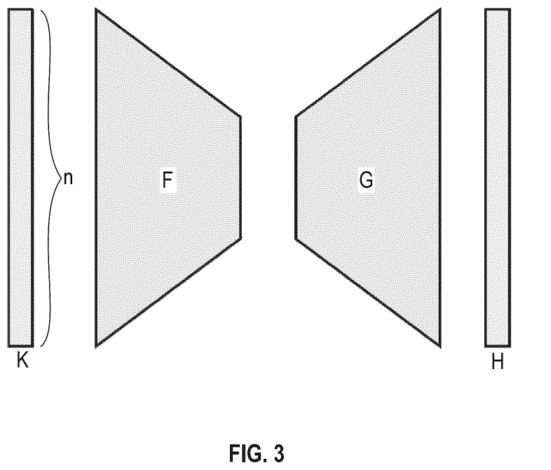

is trained on a specific task, the resulting transformation matrix may be rank deficient, meaning that it may represent only a subset of directions in the full parameter space of the corresponding model layer. To facilitate training under this condition, each layer may be altered using a bottleneck architecture, such as that illustrated in FIG. 3, which may include a k, where

$${T}_{i}^{l} = FG ,$$

where F and G are learned matrices of reduced dimensionality that define the task-specific transformation.

Sequential Training: Once the training at layer (is complete, the weights at that layer are frozen and the next layer is unfrozen for training. In some embodiments, training may conclude once loss on the validation set is observed to stop decreasing, which may indicate potential overfitting of the training set. Similar training is then performed on the next layer. This process can be repeated across all layers, resulting in weight matrices for each layer.

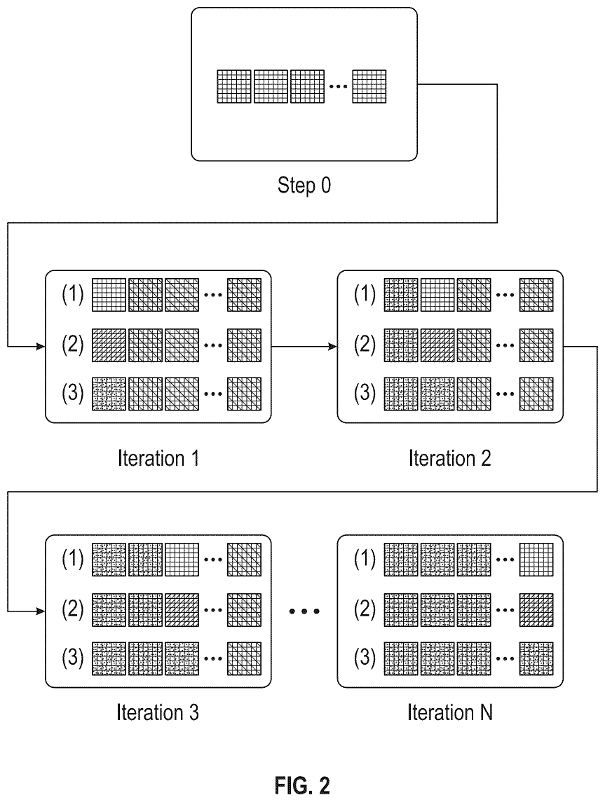

FIG. 2 illustrates an example architecture and processing sequence for generating a task-specific subspace from a trained machine learning model using rank-constrained transformation matrices associated with individual layers. FIG. 2 depicts a structured training configuration wherein different portions of the trained machine learning model are selectively optimized to capture task-dependent behavior while preserving the remainder of the trained machine learning model in an unmodified state.

In the initial configuration (Step 0), a plurality of layers are initialized. Each layer includes a corresponding weight matrix, which may be randomly initialized, inherited from a pre-trained checkpoint, or otherwise selected based on system configuration. These weight matrices may represent any portion of the trained machine learning model's internal architecture, including attention heads, feedforward modules, normalization parameters, or other learned transformations.

A block-wise training sequence can be performed in which the trained machine learning model's layers are selectively exposed to task-specific optimization. In each sub-block shown (e.g., Iteration 1 through Iteration N), a subset of layers can be activated for training while other layers are held in a frozen state. In some examples, only one layer is unfrozen during a given training phase; however, this is not limiting. Multiple layers may be jointly unfrozen based on system heuristics, layer interdependencies, or hardware optimization criteria.

Each unfrozen layer may be subject to constrained training using a low-rank factorization structure. In some embodiments, this factorization takes the form of a bottleneck representation

$${T}_{i}^{l} = FG .$$

These matrices capture a compressed embedding of the layer's response to the designated task, reducing training overhead while isolating relevant components. The factorized weights may be updated using any suitable objective function, such as a conditional language modeling loss, contrastive loss, or classification criterion, computed over a dataset representative of the designated task.

As training proceeds across different layers or layer groups, the system constructs a collection of transformation matrices that jointly represent the trained machine learning model's task-specific subspace. These matrices may be used to define a composite encoding of how the trained machine learning model performs the task across its architectural depth. In some implementations, the resulting task subspace is retained in memory or persisted for downstream operations, including subspace discrimination, augmentation, or subtraction.

The configuration shown in FIG. 2 may reflect the operation of a subspace generator (e.g., subspace generator 130 of FIG. 1), which may orchestrate the initialization, selective unfreezing, rank configuration, loss computation, and/or optimization steps. In some systems, this functionality is implemented using adapters, plug-in layers, or modular training routines integrated with existing machine learning libraries such as PyTorch or TensorFlow. In some embodiments, a rank-16 bottleneck is applied to attention layers of a transformer model with hidden dimension 5120, yielding a task representation using fewer than 1% of the total parameters in the trained machine learning model. In some embodiments, alternating layers may be selected for training to reduce cumulative update overhead while preserving sufficient representational power.

The architecture shown in FIG. 2 may be adapted to various training regimes. For instance, some configurations may initialize weights from domain-specific pretraining checkpoints, apply early stopping using validation loss thresholds, or distribute training across parallel compute units. The generated subspace matrices may be applied additively to the original weights to perform LEARN-style augmentation, or subtractively to perform UNLEARN-style suppression, depending on system objective.

FIG. 2 also illustrates an example of progressive saturation of task representation, as depicted by the increasingly dark matrix shading. This may reflect cumulative training impact, rank utilization, or magnitude of learned task alignment across iterations. The ordering of operations, number of layers processed, and specific training duration for each layer may vary across implementations.

By the end of this sequential training and freezing process, shown in FIG. 2, the set of weight matrices can capture an accurate representation of the task-dependent subspace within the weights of the Transformer model. This method may be characterized as lightweight, maintaining the computational efficiency of warm training. The layer-by-layer approach may be selected in part because the early layers contain higher-level semantic information, while the later layers contain more task/fact-specific information. Training in this method can support the most reliable identification of the tasks.

FIG. 3 illustrates an example bottleneck architecture that can be used to implement a rank-constrained transformation associated with a layer of a trained machine learning model. This architecture may be employed as part of a subspace generation process configured to extract task-specific representations from a model while limiting parameter dimensionality.

This architecture includes a pair of linear transformations: a compression operation that maps the full-dimensional input x of size n to a lower-dimensional space k<<n using transformation F, and an expansion operation that maps it back to the original size via transformation G, producing output h. The intermediate dimension k enforces a low-rank constraint on the parameterization, enabling efficient training and representation of task-specific subspaces. This structure may be employed during subspace identification or other low-rank optimization steps.

### Subspace Discrimination

Once a task-dependent subspace has been identified, it may be removed by subtracting it from the weight space on a layer-by-layer basis. While this approach may be effective at attenuating or suppressing the task of interest, it can result in performance degradation when similar tasks are evaluated (e.g., tasks that occupy overlapping or structurally similar subspaces.) Therefore, some embodiments may utilize techniques preserve mutual information between such subspaces by removing only the information that is more specifically associated with the task of interest. This operation may be referred to as subspace discrimination.

To achieve subspace discrimination, some embodiments may apply a variation of the Gram-Schmidt process. The Gram-Schmidt process is a method for orthogonalizing a set of vectors in an inner product space. Given the subspace U spanned by vectors u₁, . . . u_{N}, an orthogonal component of a vector uₖ relative to U can be computed using Equation (2), below:

$${υ}_{k}^{′} = {υ}_{k} - {\sum }_{j = 1}^{N} \frac{〈 {υ}_{k} , {u}_{j} 〉}{〈 {u}_{j} , {u}_{j} 〉} {u}_{j} . \qquad ( 2 )$$

In some embodiments, subspace discrimination is implemented using a computation of the form shown in Equation (3):

$${SV}_{k} ( {T}_{i}^{′} ) = {SV}_{k} ( {T}_{i} ) - {\sum }_{j = 1}^{N} \frac{{SV}_{k} ( {T}_{i} ) \cdot {SV}_{j} ( {T}_{o} )}{{SV}_{j} ( {T}_{o} ) \cdot {SV}_{j} ( {T}_{o} )} {SV}_{j} ( {T}_{o} ) \qquad ( 3 )$$

where Tᵢ represents the identified subspace to be removed, T₀ represents a similar task, and

$${SV}_{k} ( {T}_{i}^{′} )$$

represents the k-th singular vector of matrix Tᵢ for one of the Transformer layers [symbol] . When applied across two tasks, each pair of corresponding weight matrices is processed using the described decomposition. For cases involving three or more reference tasks, matrices such as T_{0,1}, T_{0,2} . . . . T_{0,n}, may be aggregated into a composite T₀ matrix, after which the same operation may be applied. The system may utilize Euclidean inner product computations to facilitate this process. Such an approach is inspired by prior techniques that employed linear rank decomposition to enable efficient task adaptation within large language models. While neural network parameter spaces may not be strictly Euclidean, the practical effectiveness of this strategy has motivated its adoption in connection with the inventive concepts described herein.

Initially, the similarity of tasks may be estimated through heuristic or empirical observation. However, the described approach to subspace discrimination enables a quantification of task similarity based on the extent of overlap in the associated subspaces. For example, tasks that are highly similar may yield overlapping subspace components, while dissimilar tasks may correspond to subspaces that are already orthogonal. In such cases, the discrimination process may yield limited modification, preserving the independence of unrelated task behavior.

Subspace discrimination can be a critical component of the UNLEARN algorithm, facilitating the separation of subspace components that are uniquely attributable to a designated task from those shared with other tasks. This separation allows for selective suppression of task-specific knowledge without substantially affecting model performance on semantically related tasks. Consequently, subspace discrimination can enhance the adaptability and robustness of the overall system, supporting fine-grained modification of model behavior with reduced collateral degradation.

### Example Task Removal

In some embodiments, task removal refers to the process of reducing or eliminating a designated capability from a trained machine learning model by altering one or more weight matrices associated with that capability. To accomplish this, the system may utilize singular value decomposition (SVD) reconstruction to reconstitute the modified task matrix,

$${T}_{i}^{′}$$

based on the singular values of Tᵢ and the corresponding singular vectors

$$SV ( {T}_{i}^{′} )$$

described above. The system may directly subtract the modified task matrix

$${T}_{i}^{′}$$

from the weight matrix W′, or in some cases, may perform a weighted subtraction that incorporates both the modified subspace

$${T}_{i}^{′}$$

and the original task matrix Tᵢ, according to Equation (4), below:

$${W}^{′} = W - α {T}_{i}^{′} - ( 1 - α ) {T}_{i} \qquad ( 4 )$$

where α∈[0, 1] governs the relative contribution of the two UNLEARN matrices, corresponding respectively to operations with and without subspace discrimination. By including the smoothing factor α, the system may balance the effect of subspace removal on the targeted task while mitigating unintended degradation on similar or adjacent tasks.

### Example Experiments

In some embodiments, experimental validation of some of the inventive concepts described herein was conducted using a consistent model configuration, wherein a large language model (LLM) instance based on the Llama-2-70b architecture was employed. During the subspace identification procedure, as illustrated in FIG. 2, training was carried out using a modified implementation of a publicly available library (e.g., LORALIB). Rather than applying the library to fine-tune a low-rank adapter as originally intended, the system was adapted to train the bottleneck configuration shown in FIG. 3 from an uninitialized state. In the described implementation, a rank parameter k=16 was selected. The training process targeted only attention-related weight matrices, consistent with prior findings that task-specific capabilities in transformer-based architectures may be effectively modulated through attention mechanisms. This selective modification approach may improve computational efficiency while maintaining model integrity across untargeted components.

### Example Datasets

A diverse selection of benchmarks may be used to evaluate performance degradation across similar tasks when modifying task-specific subspaces within trained machine learning models, such as large language models (LLMs). In some embodiments, evaluation is performed using two significant collections of benchmarks: Holistic Evaluation of Language Models (HELM; et al., 2023c) and the Beyond-the-Imitation-Game Benchmark (BIG-Bench; et al., 2023a).

HELM is designed to evaluate a wide range of use cases and themes, encompassing general language abilities to simple question-answering settings. This benchmark includes core metrics and utility metrics-accuracy, fairness, robustness, efficiency, and more-which may provide a detailed view into the general language capabilities of models.

Complementing HELM, BIG-Bench focuses on more niche tasks that stress the boundaries of current LLM capabilities. With 204 tasks spanning across diverse domains and fields, BIG-Bench is a benchmark for testing specific tasks that were not the primary focus of HELM. Importantly, BIG-Bench includes niche tasks that have little overlap with other tasks, offering an unbiased perspective on task interference.

Together, these datasets may support a comprehensive analysis of the influence of subspace removal on LLM performance across a spectrum of tasks. By integrating the thorough evaluation of HELM for general language abilities with the specialized tasks from BIG-Bench, certain implementations may examine how manipulation of task-specific subspaces affects both broad and targeted model capabilities. Such evaluations may help demonstrate the ability of a system, such as the UNLEARN framework, to remove a task without materially affecting adjacent tasks.

Example Task Removal without Discrimination

One experimental evaluation was conducted using the UNLEARN method configured to perform task removal based solely on task subspace identification, excluding the use of a subspace discrimination process (e.g., with α=0). In these evaluations, a single task was removed, and model performance was assessed across a range of other tasks.

Table 1 presents the observed results when the GSM8K dataset (Cobbe et al., 2021), a collection of math word problems, was targeted for removal. For the case where α equals 0, six evaluation tasks were selected, including question-answering (NarrativeQA; Kocisky et al., 2017) and general benchmarks such as MMLU (Hendrycks et al., 2021), which were selected based on dissimilarity to GSM8K. As such, the weight subspaces associated with these tasks were theoretically expected to have limited overlap. Performance comparison between the original model and the modified model demonstrated that GSM8K performance was substantially reduced by 96.5%, while the remaining tasks exhibited minimal degradation (less than 2.5%).

TABLE 1

| | Evaluation Tasks | | | | | | |
|---|---|---|---|---|---|---|---|
| α | NQA | NQ | MMLU | IMDB | RAFT | GSM8K | arithmetic |
| Base | 0.778 | 0.680 | 0.583 | 0.952 | 0.719 | 0.483 | 0.991 |
| Model | | | | | | | |
| 0 | 0.758 | 0.681 | 0.577 | 0.949 | 0.715 | 0.017 | 0.633 |
| 0.25 | 0.755 | 0.681 | 0.566 | 0.951 | 0.712 | 0.041 | 0.692 |
| 0.5 | 0.768 | 0.670 | 0.571 | 0.932 | 0.706 | 0.046 | 0.781 |
| 0.75 | 0.749 | 0.664 | 0.579 | 0.946 | 0.708 | 0.045 | 0.878 |
| 1 | 0.772 | 0.674 | 0.582 | 0.946 | 0.723 | 0.087 | 0.956 |

In the last column of Table 1, an additional benchmark task from BIG-Bench—arithmetic—was included to examine behavior when the removed task was similar to a retained task. In this scenario, although the approach successfully removed the targeted GSM8K task, it also resulted in a 33% performance drop on the arithmetic task, indicating unintended degradation.

These results illustrate that task-specific subspace removal, when performed without subspace discrimination, can result in adverse effects when overlapping task representations exist. The observed degradation in arithmetic task performance implies that the subspace associated with GSM8K contained components shared with arithmetic. This observation indicates the utility of subspace discrimination, which may help isolate the task of interest more precisely and reduce unintended interference with semantically or functionally similar tasks.

Example Task Removal with Discrimination

The last row of Table 1 with α=1 corresponds to the UNLEARN mode with subspace discrimination (also referred to as task discrimination). With GSM8K as the targeted task to be removed, the knowledge from the six unrelated tasks (first six) was once again preserved with a reduction in the GSM8K task by 82%. While the removal of the targeted task was not as pronounced when using the discrimination-based variant, the related arithmetic task was much less adversely affected with only a 3.5% reduction versus 33% when α=0.

The last row of Table 1 with α=1 corresponds to the UNLEARN method with the Task Discrimination method of Section 3.2. With GSM8K as the targeted task to be removed, the knowledge from the six unrelated tasks (first six) was once again preserved with a reduction in the GSM8K task by 82%. While the removal of the targeted task was not as pronounced when using the task discrimination method, the related arithmetic task was much less adversely affected with only a 3.5% reduction versus 33% when α=0.

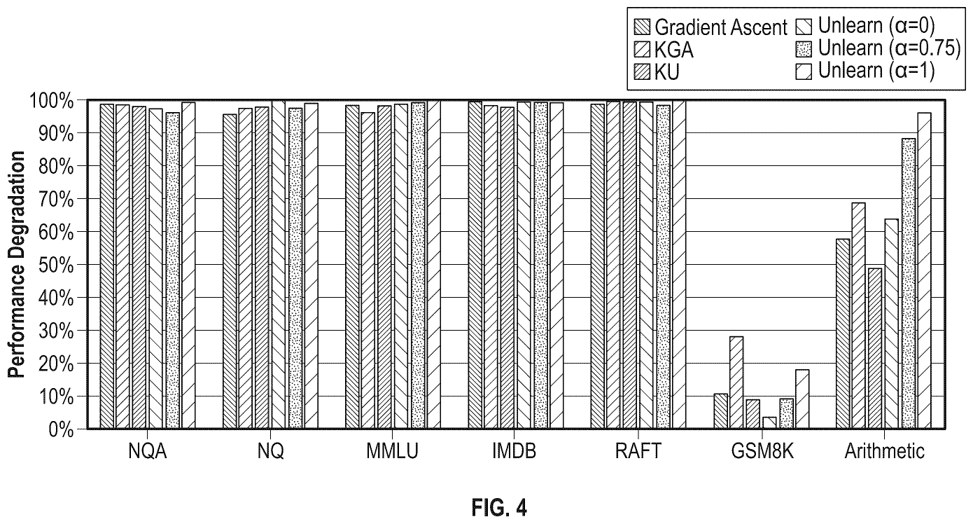

To explore the dynamics of the subspace discrimination process, a smoothing factor α may be adjusted in connection with the linear combination of subspace representations used during parameter modification. GSM8K serves as the designated task targeted for removal. As shown in Table 1, increasing a results in decreased task forgetting for GSM8K, while retention of an adjacent task—arithmetic—improves at a greater rate. For instance, with α=0.75 as illustrated in Table 1 and FIG. 4, a performance tradeoff may be achieved in which the UNLEARN approach exhibits task forgetting for GSM8K comparable to prior methods, such as Knowledge Unlearning (KU), reaching a 91% reduction, while preserving performance on the arithmetic task with only an 11% reduction (compared to a 50% reduction observed using KU).

When arithmetic was the targeted task, the results had deleterious effects on GSM8K as well. Varying values of a (i.e. making the discrimination process more aggressive) had the unintended effect of reducing the unlearning impact on both tasks. This suggests these tasks' subspaces entirely overlap, preventing the successful discrimination of the two.

FIG. 4 illustrates an example of comparative task performance degradation when GSM8K is designated as the target task for removal. FIG. 4 shows the relative impact of multiple unlearning techniques on a variety of benchmark tasks, including NQA, NQ, MMLU, IMDB, RAFT, GSM8K, and arithmetic. Each method—Gradient Ascent, Knowledge Gap Alignment (KGA), Knowledge Unlearning (KU), and UNLEARN with different values of the smoothing factor α—produces a unique profile of degradation across tasks. The height of each bar indicates the percentage of performance lost relative to a baseline model. UNLEARN configurations demonstrate selective degradation on the targeted GSM8K task while preserving higher performance on unrelated tasks, including arithmetic, highlighting the effects of subspace discrimination and smoothing. FIG. 4 may be used to assess the ability of each method to isolate and suppress task-specific knowledge without adversely impacting adjacent capabilities.

### Example Rank Selection for Task-Specific Subspace Representations

The impact of varying the rank associated with the rank-deficient matrices during subspace identification was evaluated to assess tradeoffs between performance retention and parameter efficiency. As shown Table 2, the system was configured to remove the task associated with NarrativeQA (NQA), and the rank parameter k was varied across multiple values: {1, 2, 4, 8, 16, 32}.

TABLE 2

| | Evaluation Tasks | | |
|---|---|---|---|
| k | NQA | NQ | MMLU |
| Base Model | 0.778 | 0.68 | 0.583 |
| 1 | 0.167 | 0.599 | 0.58 |
| 2 | 0.151 | 0.609 | 0.564 |
| 4 | 0.128 | 0.624 | 0.568 |
| 8 | 0.136 | 0.627 | 0.58 |
| 16 | 0.135 | 0.628 | 0.581 |
| 32 | 0.134 | 0.619 | 0.579 |

The evaluation results indicate that performance on unrelated tasks (e.g., NQ, MMLU) is largely maintained for k≥4, whereas lower values of k result in modest degradation. For smaller ranks, the system was less effective at forgetting the designated task and introduced greater degradation on tasks occupying similar subspaces.

These results suggest that the dimensionality of the subspace representation can, in some cases, be reduced significantly without compromising functionality. This is plausible given that the parameter subspace corresponding to a designated task often occupies a small portion of the overall weight space. For instance, in the Llama-2-70B model, where the weight matrix dimension N is 5120, removal of a single task subspace with intrinsic rank k=4 corresponds to a reduction of approximately 0.16% in overall parameters. Moreover, this reduction scales proportionally with the number of orthogonal tasks, such that a 10% parameter reduction could be achieved by removing 66 distinct subspaces. Such flexibility may enhance applicability in resource-constrained environments where reductions in parameter count are desirable without materially affecting task-specific performance.

### LEARN-Based Task Enhancement

The UNLEARN methodology provides a framework for enhancing model performance on particular tasks. This operational mode, sometimes referred to as “LEARN,” applies the UNLEARN algorithm for training on new information. This method aims to add knowledge and/or amplify the representation of a given task within the trained machine learning model, leading to improved performance on that task.

The LEARN approach can use some or all of the same principles as UNLEARN while inverting the application to perform task enhancement instead of task removal. Specifically, some embodiment of the LEARN method can include identifying the subspace associated with a desired task using a subspace generation process; this step can be substantially identical to UNLEARN. In some cases, the difference lies in task addition rather than task removal; the corresponding weight update is implemented using the transformation shown in Equation (5):

$${W}^{′} = W + {T}_{i}^{′} \qquad ( 5 )$$

This addition enhances performance on the designated task, with the matrix

$${T}_{i}^{′}$$

operating as an overlay on the existing weight matrix, similar in function to adapter-based techniques in language model tuning. The addition can be applied to one or more selected layers of the trained machine learning model and can be implemented as a rank-constrained transformation.

### Example LEARN Evaluation

To assess the operational effectiveness of the LEARN methodology, a series of experiments were performed on tasks for which pre-trained models exhibited suboptimal baseline performance yet retained the potential for improvement through targeted fine-tuning. Identifying tasks that meet these criteria for larger language models (e.g., those exceeding 50 billion parameters) presents challenges, as such models are typically trained on expansive datasets that limit the availability of genuinely unseen information. To mitigate this issue, the evaluation was conducted using a reduced-scale language model, thereby constraining total learning capacity and enabling measurable gains through targeted enhancement.

The experimental setup was consistent with prior configurations, with the exception that the trained machine learning model used was Llama-2-7b. The benchmark used for evaluation was LegalBench, a dataset collaboratively developed by legal professionals and machine learning practitioners to evaluate legal reasoning capabilities in language models. The baseline performance of Llama-2-7b on this benchmark ranged from 30% to 50% across various tasks, indicating clear opportunities for performance improvement.

Application of the LEARN techniques to the trained machine learning model demonstrated substantial performance gains across all evaluated tasks. As shown in Table 3, application of LEARN resulted in consistent task-specific improvements, including an overall increase in average performance of approximately 40% relative to the unmodified baseline model. Table 3 includes a comparative analysis between LEARN and traditional Low-Rank Adaptation (LoRA) fine-tuning methods.

TABLE 3

| Task | Base Model | LEARN | LoRA |
|---|---|---|---|
| Issue | 50.1 | 73.4 | 72.9 |
| Rule | 42.7 | 61.8 | 63.1 |
| Conclusion | 53.9 | 69.3 | 69.6 |
| Interpretation | 48.1 | 68.1 | 67.4 |
| Rhetorical | 45.4 | 62.5 | 61.2 |
| Average | 48.0 | 67.0 | 66.8 |

### Comparison to Existing Methods

The UNLEARN and LEARN methodologies can be applied across a range of model adaptation workflows. The framework can define a generalized mechanism suitable for full fine-tuning and/or Parameter Efficient Fine-Tuning (PEFT) techniques. In either configuration, the method can involve adding and/or subtracting task-specific matrices to or from the weight matrices of a trained machine learning model, depending on whether enhancement (e.g., LEARN) or attenuation (e.g., UNLEARN) is desired.

Use of a common set of task-specific transformations across modes can simplify model management and can reduce computational and storage overhead. This approach can support efficient deployment in systems that incorporate model versioning, modular adaptation, or operational constraints requiring lightweight updates.

### 5.2 Task Performance

In scenarios involving semantically similar tasks, differences between the UNLEARN and LEARN methodologies and existing approaches can become more apparent. In the LEARN configuration illustrated in Table 3, both LEARN and LoRA demonstrate comparable improvements in task-specific performance, indicating that each approach can be effective in enhancing model behavior. In the UNLEARN configuration, the system can discriminate between related tasks and selectively attenuate only the designated task while minimizing impact on similar tasks.

A comparative evaluation was conducted between the UNLEARN method and several state-of-the-art algorithms, including Gradient Ascent (GA), Knowledge Gap Alignment (KGA), and Knowledge Unlearning (KU). As shown in Table 4, existing methods exhibit difficulty in effectively isolating the task of interest, resulting in performance degradation on secondary tasks that share representational similarities. For instance, when NarrativeQA was designated as the target task, the UNLEARN method reduced task performance from 0.778 to 0.135, while preserving NaturalQuestions performance at 0.628 (from 0.680).

TABLE 4

| Targeted | | Evaluation Tasks | | | | | | |
|---|---|---|---|---|---|---|---|---|
| Task | Model | NQA | NQ | MMLU | IMDB | RAFT | GSM8K | arithmetic |
| | Base Model | 0.778 | 0.680 | 0.583 | 0.952 | 0.719 | 0.483 | 0.991 |
| GSM8K | Gradient Ascent | 0.768 | 0.651 | 0.574 | 0.949 | 0.710 | 0.052 | 0.574 |
| | KGA | 0.767 | 0.664 | 0.561 | 0.937 | 0.718 | 0.136 | 0.682 |
| | KU | 0.763 | 0.666 | 0.574 | 0.933 | 0.716 | 0.043 | 0.487 |
| | UNLEARN (α = 0) | 0.758 | 0.681 | 0.577 | 0.949 | 0.715 | 0.017 | 0.633 |
| | UNLEARN (α = 0.25) | 0.755 | 0.681 | 0.566 | 0.951 | 0.712 | 0.041 | 0.692 |
| | UNLEARN (α = 0.5) | 0.768 | 0.670 | 0.571 | 0.932 | 0.706 | 0.046 | 0.781 |
| | UNLEARN (α = 0.75) | 0.749 | 0.664 | 0.579 | 0.946 | 0.708 | 0.045 | 0.878 |
| | UNLEARN (α = 1.0) | 0.772 | 0.674 | 0.582 | 0.946 | 0.723 | 0.087 | 0.956 |
| arithmetic | Gradient Ascent | 0.782 | 0.663 | 0.577 | 0.953 | 0.713 | 0.215 | 0.084 |
| | KGA | 0.767 | 0.675 | 0.581 | 0.939 | 0.700 | 0.105 | 0.017 |
| | KU | 0.760 | 0.672 | 0.567 | 0.942 | 0.719 | 0.183 | 0.063 |
| | UNLEARN (α = 0) | 0.757 | 0.680 | 0.578 | 0.949 | 0.716 | 0.087 | 0.028 |
| | UNLEARN (α = 0.25) | 0.771 | 0.673 | 0.584 | 0.949 | 0.717 | 0.214 | 0.229 |
| | UNLEARN (α = 0.5) | 0.762 | 0.680 | 0.575 | 0.941 | 0.713 | 0.277 | 0.462 |
| | UNLEARN (α = 0.75) | 0.773 | 0.676 | 0.571 | 0.948 | 0.709 | 0.363 | 0.628 |
| | UNLEARN (α = 1.0) | 0.771 | 0.681 | 0.569 | 0.955 | 0.712 | 0.461 | 0.825 |
| NQA | Gradient Ascent | 0.094 | 0.415 | 0.573 | 0.945 | 0.709 | 0.469 | 0.978 |
| | KGA | 0.183 | 0.229 | 0.581 | 0.942 | 0.717 | 0.482 | 0.976 |
| | KU | 0.163 | 0.329 | 0.569 | 0.949 | 0.701 | 0.479 | 0.976 |
| | UNLEARN (α = 0) | 0.118 | 0.263 | 0.567 | 0.966 | 0.702 | 0.466 | 0.976 |
| | UNLEARN (α = 0.25) | 0.119 | 0.332 | 0.577 | 0.952 | 0.717 | 0.468 | 0.980 |
| | UNLEARN (α = 0.5) | 0.124 | 0.427 | 0.579 | 0.947 | 0.709 | 0.482 | 0.988 |
| | UNLEARN (α = 0.75) | 0.133 | 0.514 | 0.575 | 0.946 | 0.711 | 0.479 | 0.985 |
| | UNLEARN (α = 1.0) | 0.135 | 0.628 | 0.581 | 0.969 | 0.723 | 0.460 | 0.989 |
| NQ | Gradient Ascent | 0.483 | 0.184 | 0.554 | 0.940 | 0.693 | 0.477 | 0.963 |
| | KGA | 0.501 | 0.243 | 0.557 | 0.946 | 0.697 | 0.479 | 0.989 |
| | KU | 0.416 | 0.113 | 0.558 | 0.926 | 0.712 | 0.468 | 0.973 |
| | UNLEARN (α = 0) | 0.419 | 0.142 | 0.570 | 0.936 | 0.717 | 0.464 | 0.979 |
| | UNLEARN (α = 0.25) | 0.487 | 0.141 | 0.571 | 0.950 | 0.714 | 0.481 | 0.984 |
| | UNLEARN (α = 0.5) | 0.583 | 0.146 | 0.578 | 0.947 | 0.708 | 0.479 | 0.985 |
| | UNLEARN (α = 0.75) | 0.655 | 0.146 | 0.569 | 0.941 | 0.711 | 0.474 | 0.991 |
| | UNLEARN (α = 1.0) | 0.703 | 0.147 | 0.567 | 0.941 | 0.716 | 0.471 | 0.983 |

By contrast, all three reference algorithms demonstrated degradation on the secondary task: GA reduced NaturalQuestions to 0.415; KGA reduced it to 0.229; and KU reduced it to 0.329.

While these approaches achieved reduction in NarrativeQA performance (GA: 0.094, KGA: 0.183, KU: 0.163), they lacked the granularity to isolate task-specific influence without affecting related functionality.

Through subspace-based discrimination techniques, the UNLEARN method can facilitate selective knowledge removal while maintaining performance on semantically overlapping tasks. This capability may be particularly advantageous in benchmark environments where related queries correspond to shared or intersecting parameter subspaces. Accordingly, the methodology can support model adaptation scenarios requiring fine-grained precision in task targeting and preservation.

### Extensions of the Inventive Concepts

The inventive concepts described herein can be applied to a wide range of task-specific knowledge management scenarios. While the disclosed examples illustrate operations such as the attenuation of broad domain knowledge, the same or similar subspace-based methodologies can be utilized for the selective removal of specific facts, responses, or behaviors. This functionality may be applicable in contexts involving private, sensitive, or regulated information, where precision removal is required without retraining the entire model.

The disclosed techniques can support task discrimination at scale. Although certain embodiments demonstrate selective unlearning of a limited set of tasks, the underlying framework is compatible with configurations in which subspace discrimination is applied to larger or more granular sets of tasks, including those with overlapping representational characteristics.

Subspace manipulation techniques described herein are not limited to attention-related parameters. While some embodiments apply rank-constrained transformations to attention weights—consistent with parameter-efficient fine-tuning architectures—the same or similar techniques may be applied to other layers or components within a trained machine learning model. This flexibility can enable broader adaptation strategies, including domain transfer, behavioral modification, or selective enhancement of latent capabilities.

The described framework, including its LEARN and UNLEARN operational modes, enables targeted control over model behavior and can be integrated into a variety of training, deployment, or compliance-driven systems.

### CONCLUSION

Some inventive concepts described herein relate to systems or methods for selectively modifying the behavior of trained machine learning models using task-specific subspace manipulation techniques. In various embodiments, UNLEARN techniques can be used to attenuate or remove task-related knowledge from a model through operations involving subspace identification or subspace discrimination. Such techniques can be implemented in multiple forms and may offer advantages in generality, computational efficiency, implementation simplicity, or precision of task-level adjustment.

Evaluations across representative tasks indicate that UNLEARN-related operations can reduce the influence of specific tasks while preserving performance on other tasks not intended for modification. This capability may support granular control over model behavior and can be relevant in contexts involving privacy considerations, safety requirements, or selective feature suppression.

Some inventive concepts described herein relate to systems or methods for applying subspace-based transformations to introduce or amplify task-specific functionality. Such LEARN techniques can be used to augment a trained model with new behaviors and may achieve performance levels comparable to parameter-efficient tuning methods such as Low-Rank Adaptation (LoRA). In some implementations, subspace discrimination may be incorporated to mitigate unintended effects on related tasks during task enhancement.

UNLEARN or LEARN frameworks can be applied independently or in combination with one another, and may be integrated into model training, editing, deployment, or compliance workflows. These frameworks can support a range of operational configurations and may be suitable for scalable, modular control over the functionality of large-scale machine learning models.

### Terminology

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is otherwise understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

In some embodiments, certain operations, acts, events, or functions of any of the algorithms described herein can be performed in a different sequence, can be added, merged, or left out altogether (e.g., not all are necessary for the practice of the algorithms). In some embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. In some embodiments, one or more of the components of the system 100 can be implemented in a remote distributed computing system. In this context, a remote distributed computing system or cloud-based service can refer to a service hosted by one more computing resources that are accessible to end users over a network, for example, by using a web browser or other application on a client device to interface with the remote computing resources. For example, a service provider may provide the system 100 by managing computing resources configured to implement various aspects of the system and by providing access to the system 100 to end users via a network.

When implemented as a cloud-based service, various components of the system 100 can be implemented using containerization or operating-system-level virtualization, or other virtualization technique. For example, one or more components of the system 100 can be implemented as separate software containers or container instances. Each container instance can have certain resources (e.g., memory, processor, etc.) of the underlying host computing system assigned to it, but may share the same operating system and may use the operating system's system call interface. Each container may provide an isolated execution environment on the host system, such as by providing a memory space of the host system that is logically isolated from memory space of other containers. Further, each container may run the same or different computer applications concurrently or separately, and may interact with each other. Although reference is made herein to containerization and container instances, it will be understood that other virtualization techniques can be used. For example, the components can be implemented using virtual machines using full virtualization or paravirtualization, etc. Thus, where reference is made to “containerized” components, it should be understood that such components may additionally or alternatively be implemented in other isolated execution environments, such as a virtual machine environment.

Likewise, the data repositories shown or described can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain features or elements may be described in the context of particular embodiments, it will be appreciated that any feature, function, or component disclosed herein with respect to one embodiment may be combined with any other embodiment unless expressly stated otherwise or unless such combinations would be incompatible. The disclosure is intended to cover all such combinations and variations, and no limitation is intended by the identification of specific embodiments or examples.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. A method for selectively modifying a trained machine learning model with respect to a designated task, the method including:
obtaining a trained machine learning model including a plurality of layers, each layer defined by a respective weight matrix;
identifying a designated task, the designated task corresponding to a functionality associated with the trained machine learning model;
for each layer in the plurality of layers:
maintaining weight matrices of all other layers of the plurality of layers of the trained machine learning model in an unmodified state, and
generating a task subspace matrix corresponding to the designated task by determining a rank-constrained transformation associated with the respective layer, wherein the transformation is computed using data representative of the designated task and applied solely one or more weights of the respective layer;
forming a composite task subspace by aggregating the task subspace matrices generated across the plurality of layers, the composite task subspace representing parameter contributions in the trained machine learning model specific to the designated task; and
modifying at least one weight matrix of the trained machine learning model in accordance with the composite task subspace, thereby adjusting a contribution of the designated task to an output of the trained machine learning mode.

2. The method of claim 1, further including:
identifying one or more reference subspaces, each reference subspace corresponding to a task distinct from the designated task, and each reference subspace being derived by computing a rank-constrained transformation based on data representative of the respective distinct task, wherein, for each computation, all other weight matrices of the trained machine learning model are maintained in an unmodified state;
generating a modified subspace representation by discriminating the composite task subspace from the one or more reference subspaces, the modified subspace representation retaining components unique to the designated task and excluding components shared with the reference subspaces,
wherein modifying includes modifying the at least one weight matrix of the trained machine learning model in accordance with the modified subspace representation.

3. The method of claim 2, wherein discriminating the composite task subspace from the one or more reference subspaces includes orthogonalizing vector components of the composite task subspace with respect to the reference subspaces, such that only components not shared with the reference subspaces are retained in a modified subspace representation.

4. The method of claim 2, wherein modifying at least one weight matrix includes performing a subtraction of the modified subspace representation from a corresponding one of the at least one weight matrix, to attenuate functionality associated with the designated task, thereby reducing a contribution of the designated task to an output of the trained machine learning model.

5. The method of claim 2, wherein the modified subspace representation is generated as a linear interpolation between the task subspace matrix and a corresponding discriminated task subspace matrix, the interpolation governed by a smoothing factor configured to balance an extent of task attenuation and preservation of performance on similar tasks.

6. The method of claim 1, wherein identifying the designated task includes selecting the designated task for attenuation based on a determination that the functionality associated with the designated task is redundant with respect to an external system, such that the modification of the trained machine learning model reduces parameter usage attributable to the designated task while preserving performance on unrelated tasks.

7. The method of claim 1, wherein modifying at least one weight matrix includes performing an addition of the composite task subspace to the at least one weight matrix, thereby increasing a contribution of the designated task to the output of the trained machine learning model.

8. The method of claim 7, wherein the addition of the composite task subspace to the at least one weight matrix is performed in a manner that maintains approximate orthogonality with preexisting task subspaces, thereby enhancing performance on the designated task without adversely affecting performance on semantically similar tasks.

9. The method of claim 1, wherein generating the task subspace matrix for each respective layer includes determining a low-rank transformation matrix by factorizing the transformation as a product of a first matrix and a second matrix, each having a dimensionality lower than that of the corresponding weight matrix, the factorization implementing a bottleneck architecture configured to reduce parameter dimensionality.

10. The method of claim 1, wherein generating the task subspace matrices includes sequentially training across the plurality of layers of layers by, for each layer in the plurality of layers, computing the task subspace matrix while maintaining all other weight matrices in the plurality of layers in an unmodified state, thereby isolating training to the respective layer.

11. The method of claim 1, wherein the at least one weight matrix includes one or more attention-related weight matrices of the trained machine learning model.

12. The method of claim 1, wherein generating the task subspace matrix for each respective layer includes computing a low-rank transformation defined by a product of a first matrix and a second matrix, the product being constrained such that each matrix has fewer parameters than the corresponding weight matrix, the computation implementing a bottleneck structure to reduce parameter dimensionality while preserving task-specific expressiveness.

13. The method of claim 1, wherein the at least one weight matrix includes one or more weight matrices within attention layers of the trained machine learning model, and wherein modifying the at least one weight matrix is confined to the attention-related weight matrices, thereby limiting an effect of the modification to mechanisms governing token-to-token interactions within the trained machine learning model.

14. The method of claim 1, wherein the modifying of the at least one weight matrix is performed without retraining all of the plurality of layers of the trained machine learning model and without requiring access to any original training data used to produce the trained machine learning model.

15. A non-transitory computer-readable medium storing instructions that, when executed by one or more processors, cause a computing system to perform a method comprising:
obtaining a trained machine learning model including a plurality of layers, each layer defined by a respective weight matrix;
identifying a designated task, the designated task corresponding to a functionality associated with the trained machine learning model;
for each layer in the plurality of layers:
maintaining weight matrices of all other layers of the plurality of layers of the trained machine learning model in an unmodified state, and
generating a task subspace matrix corresponding to the designated task by determining a rank-constrained transformation associated with the respective layer, wherein the transformation is computed using data representative of the designated task and applied solely one or more weights of the respective layer;
forming a composite task subspace by aggregating the task subspace matrices generated across the plurality of layers, the composite task subspace representing parameter contributions in the trained machine learning model specific to the designated task; and
modifying at least one weight matrix of the trained machine learning model in accordance with the composite task subspace, thereby adjusting a contribution of the designated task to an output of the trained machine learning mode.

16. The non-transitory computer-readable medium of claim 15, further including:
identifying one or more reference subspaces, each reference subspace corresponding to a task distinct from the designated task, and each reference subspace being derived by computing a rank-constrained transformation based on data representative of the respective distinct task, wherein, for each computation, all other weight matrices of the trained machine learning model are maintained in an unmodified state;
generating a modified subspace representation by discriminating the composite task subspace from the one or more reference subspaces, the modified subspace representation retaining components unique to the designated task and excluding components shared with the reference subspaces,
wherein modifying includes modifying the at least one weight matrix of the trained machine learning model in accordance with the modified subspace representation.

17. The non-transitory computer-readable medium of claim 15, wherein discriminating the composite task subspace from the one or more reference subspaces includes orthogonalizing vector components of the composite task subspace with respect to the reference subspaces, such that only components not shared with the reference subspaces are retained in a modified subspace representation.

18. A system for selectively modifying a trained machine learning model with respect to a designated task, the system comprising:
one or more processors; and
memory storing instructions that, when executed by the one or more processors, cause the system to:
obtain a trained machine learning model including a plurality of layers, each layer defined by a respective weight matrix;
identify a designated task, the designated task corresponding to a functionality associated with the trained machine learning model;
for each layer in the plurality of layers:
maintain weight matrices of all other layers of the plurality of layers of the trained machine learning model in an unmodified state, and
generate a task subspace matrix corresponding to the designated task by determining a rank-constrained transformation associated with the respective layer, wherein the transformation is computed using data representative of the designated task and applied solely one or more weights of the respective layer;
form a composite task subspace by aggregating the task subspace matrices generated across the plurality of layers, the composite task subspace representing parameter contributions in the trained machine learning model specific to the designated task; and
modify at least one weight matrix of the trained machine learning model in accordance with the composite task subspace, thereby adjusting a contribution of the designated task to an output of the trained machine learning mode.

19. The system of claim 18, wherein the instructions further cause the system to:
identify one or more reference subspaces, each reference subspace corresponding to a task distinct from the designated task, and each reference subspace being derived by computing a rank-constrained transformation based on data representative of the respective distinct task, wherein, for each computation, all other weight matrices of the trained machine learning model are maintained in an unmodified state; and
generate a modified subspace representation by discriminating the composite task subspace from the one or more reference subspaces, the modified subspace representation retaining components unique to the designated task and excluding components shared with the reference subspaces,
wherein modifying includes modifying the at least one weight matrix of the trained machine learning model in accordance with the modified subspace representation.

20. The system of claim 18, wherein discriminating the composite task subspace from the one or more reference subspaces includes orthogonalizing vector components of the composite task subspace with respect to the reference subspaces, such that only components not shared with the reference subspaces are retained in a modified subspace representation.
